(19) United States
(12) Patent Application Publication
(10) Pub. No.: US 2025/0309467 A1
(43) Pub. Date: Oct. 2, 2025

(54) METHOD OF MANUFACTURING SOLID-STATE BATTERY

(71) Applicant: HONDA MOTOR CO., LTD., Tokyo (JP)

(72) Inventors: Takashi TOYOSHIMA, Saitama (JP); Kenta UMETSU, Saitama (JP); Yohei NOJI, Saitama (JP); Kosei MIYATA, Saitama (JP); Takahiro MACHIDA, Saitama (JP); Akihiro YOSHIZAWA, Saitama (JP)

(21) Appl. No.: 19/064,731

(22) Filed: Feb. 27, 2025

(30) Foreign Application Priority Data
Mar. 30, 2024 (JP) 2024-058329

(51) Int. Cl. H01M 50/403; H01M 4/62; H01M 10/0525; H01M 10/0587; H01M 50/411; H01M 50/457

(52) U.S. Cl. CPC H01M 50/403; H01M 4/623; H01M 10/0525; H01M 10/0587; H01M 50/411; H01M 50/457

(57) ABSTRACT

A method of manufacturing a solid-state battery includes a laminate forming step of forming a solid electrolyte layer-positive electrode layer laminate. The laminate forming step includes: a transferring-pressing step of transferring and pressing a first solid electrolyte layer onto the positive electrode active material layer of the positive electrode layer; a first pressurizing step of pressurizing the positive electrode layer and the first solid electrolyte layer transferred to the positive electrode layer; and a second pressurizing step of disposing and pressurizing a second solid electrolyte layer onto the first solid electrolyte layer after the first pressurizing step. In the method, a pressing pressure in the transferring-pressing step is lower than a pressing pressure in the first pressurizing step, and a content of a binder in the first solid electrolyte layer is equal to or greater than a content of a binder in the second solid electrolyte layer.

This application is based on and claims the benefit of priority from Japanese Patent Application No. 2024-058329, filed on 30 Mar. 2024, the content of which is incorporated herein by reference.

### BACKGROUND OF THE INVENTION

### Field of the Invention

The present invention relates to a method of manufacturing a solid-state battery.

### Related Art

In recent years, research and development of secondary batteries that contribute to energy efficiency has been carried out in order to ensure many people have access to affordable, reliable, sustainable, and advanced energy.

As such secondary batteries, solid-state batteries including lithium metal batteries, lithium-ion secondary batteries, etc. have been known, in which a solid electrolyte layer is interposed between a positive electrode layer and a negative electrode.

There are disclosed techniques relating to the solid-state batteries, and an example thereof is directed to an all-solid-state battery in which a first solid electrolyte layer is disposed adjacent to a negative electrode, a second solid electrolyte layer is interposed between the first solid electrolyte layer and a positive electrode, and the first solid electrolyte layer has a Young's modulus smaller than that of the second solid electrolyte layer (see, for example, see Japanese Unexamined Patent Application, Publication No. 2022-108202).
Patent Document 1: Japanese Unexamined Patent Application, Publication No. 2022-108202

### SUMMARY OF THE INVENTION

An object of the technique disclosed in Japanese Unexamined Patent Application, Publication No. 2022-108202 is to suppress deterioration of interfacial contactability between the solid electrolyte layer and the positive and negative electrode layers and to suppress a voltage drop during self-discharge. On the other hand, forming the positive electrode active material layer as thick as possible is conceivable as a means for increasing the capacity of the solid-state battery. The positive electrode active material layer having such a large thickness is preferably densified by pressing, and at the time of the pressing, the positive electrode active material layer is easily stretched. For this reason, it is preferable that the solid electrolyte layer disposed in contact with the positive electrode active material layer is configured to be capable of following the stretch of the positive electrode active material layer at the time of the pressing to thereby have improved bondability with the positive electrode active material layer.

The present invention has been made in view of the above circumstances, and an object of the present invention is to provide a method of manufacturing a solid-state battery capable of allowing a solid electrolyte layer in contact with a positive electrode layer to improve in bondability with the positive electrode layer.

A first aspect of the present invention is directed to a method of manufacturing a solid-state battery, the method including: forming a solid electrolyte layer-positive electrode layer laminate by laminating a solid electrolyte layer and a positive electrode layer including a positive electrode current collector layer and a positive electrode active material layer such that the solid electrolyte layer is disposed on the positive electrode active material layer. The forming the solid electrolyte layer-positive electrode layer laminate includes: transferring and pressing a first solid electrolyte layer onto the positive electrode active material layer of the positive electrode layer; pressurizing the positive electrode layer and the first solid electrolyte layer transferred to the positive electrode layer; and disposing and pressurizing a second solid electrolyte layer onto the first solid electrolyte layer after the pressurizing the positive electrode layer and the first solid electrolyte layer. In the method, a pressing pressure in the transferring and pressing the first solid electrolyte layer is lower than a pressing pressure in the pressurizing the positive electrode layer and the first solid electrolyte layer, and a content of a binder in the first solid electrolyte layer is equal to or greater than a content of a binder in the second solid electrolyte layer.

The first aspect provides a method of manufacturing a solid-state battery capable of allowing the solid electrolyte layer in contact with the positive electrode layer to improve in bondability with the positive electrode layer.

According to a second aspect of the present invention, in the method of the first aspect, the pressing pressure in the transferring and pressing the first solid electrolyte layer is lower than a pressing pressure in the disposing and pressurizing the second solid electrolyte layer.

According to the second aspect, also during the disposing and pressurizing the second solid electrolyte layer, the solid electrolyte layer in contact with the positive electrode layer is likely to be stretched and follow the positive electrode layer, whereby the bondability with the positive electrode layer can be improved.

According to a third aspect of the present invention, in the method of the first or second aspect, the first solid electrolyte layer is thinner than the second solid electrolyte layer.

According to the third aspect, the solid electrolyte layer in contact with the positive electrode layer is likely to be stretched and follow the positive electrode layer, whereby the bondability with the positive electrode layer can be improved.

According to a fourth aspect of the present invention, in the method of any one of the first to third aspects, the content of the binder in the first solid electrolyte layer is 5 vol % or more and 25 vol % or less.

According to the fourth aspect, the solid electrolyte layer in contact with the positive electrode layer is likely to be stretched and follow the positive electrode layer, whereby the bondability with the positive electrode layer can be improved.

According to a fifth aspect of the present invention, in the method of any one of the first to fourth aspects, the binder in the first solid electrolyte layer includes a fluorine-based binder.

According to the fifth aspect, the first solid electrolyte layer can be easily pressed at a high pressure and thinned.

According to a sixth aspect of the present invention, in the method of any one of first to fifth aspects, the first solid electrolyte layer has a thickness of 3 μm or more and 15 μm or less.

The sixth aspect makes it possible to obtain a solid-state battery in which the first solid electrolyte layer is suitably thinned.

According to a seventh aspect of the present invention, in the method of any one of the first to sixth aspects, the pressing pressure in the transferring and pressing the first solid electrolyte layer is 100 MPa.

According to the seventh aspect, also during the pressurizing the positive electrode layer and the first solid electrolyte layer, the solid electrolyte layer in contact with the positive electrode layer is likely to be stretched and follow the positive electrode layer, whereby the bondability with the positive electrode layer can be improved.

An eighth aspect of the present invention, in the method of any one of the first to seventh aspects, a pressing pressure in the disposing and pressurizing the second solid electrolyte layer is 150 MPa.

According to the eighth aspect, the second solid electrolyte layer is appropriately pressurized without being excessively pressurized, whereby the bondability between the second solid electrolyte layer and the first solid electrolyte layer can be improved.

### BRIEF DESCRIPTION OF THE DRAWINGS

FIG. 1 is a conceptual cross-sectional view illustrating a configuration of a solid-state battery according to an embodiment of the present invention;

FIG. 2A is a diagram illustrating a part of steps of a method of manufacturing a solid-state battery according to the embodiment of the present invention; and

FIG. 2B is a diagram illustrating a part of the steps of the method of manufacturing a solid-state battery according to the embodiment of the present invention.

### DETAILED DESCRIPTION OF THE INVENTION

### Solid-State Battery

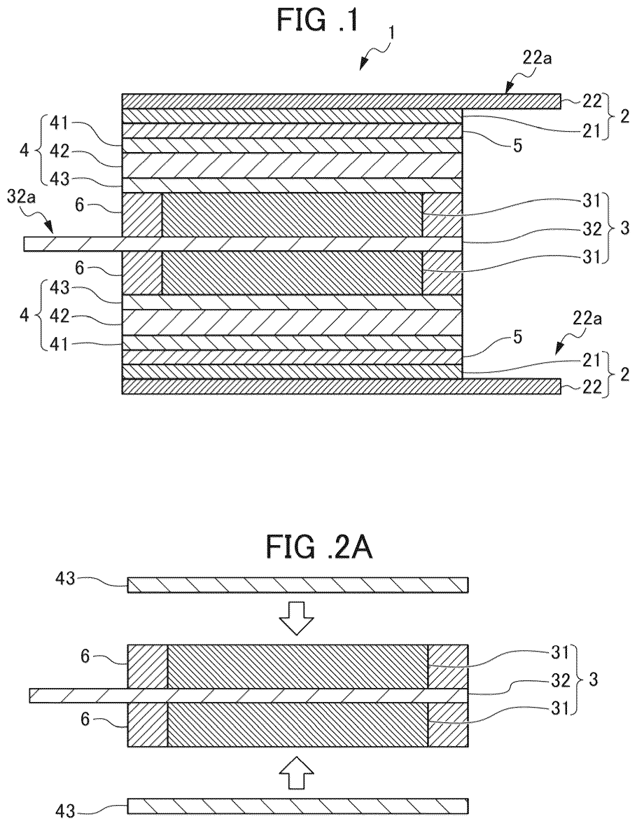

As illustrated in FIG. 1, a solid-state battery 1 manufactured by a manufacturing method according to an embodiment of the present invention includes an electrode laminate in which a negative electrode layer 2, a solid electrolyte layer 4, and a positive electrode layer 3 are laminated in this order. In the description of the present embodiment, the structure illustrated in FIG. 1, in which the negative electrode layer 2, the solid electrolyte layer 4, the positive electrode layer 3, the solid electrolyte layer 4, and the negative electrode layer 2 are laminated in this order, will be referred to as a laminate structure of the solid-state battery 1. However, the structure of the solid-state battery 1 is not limited to the foregoing. The solid-state battery 1 may include a component that can be used for a solid-state battery, such as an exterior jacket and the like, in addition to the electrode laminate illustrated in FIG. 1.

The solid electrolyte layer 4 of the solid-state battery 1 includes at least a first solid electrolyte layer 43 disposed toward the positive electrode layer 3 and a second solid electrolyte layer 42 disposed adjacent to the first solid electrolyte layer 43. The solid electrolyte layer 4 may include a third solid electrolyte layer 41 that is disposed toward the negative electrode layer 2. In the present embodiment, the solid electrolyte layer 4 is described as being composed of the above-described three layers. An intermediate layer 5 may be optionally interposed between the negative electrode layer 2 and the solid electrolyte layer 4.

The solid-state battery 1 may be a solid-state lithium-ion secondary battery or a lithium metal secondary battery, without any particular limitation.

### Negative Electrode Layer

The negative electrode layer 2 includes a negative electrode active material layer 21 and a negative electrode current collector layer 22. The negative electrode active material layer 21 may be constituted by any material that can be used as a negative electrode active material of a solid-state battery, without any particular limitation. Examples of the negative electrode active material constituting the negative electrode active material layer 21 include a silicon-based active material such as lithium metal, a lithium alloy, Si, a Si alloy, etc., a lithium transition metal oxide such as lithium titanate (Li₄Ti₅O₁₂), etc., a transition metal oxide such as TiO₂, Nb₂O₃, WO₃, etc., a metal sulfide, a metal nitride, a carbon material such as graphite, soft carbon, hard carbon, etc., metal indium, and the like.

The negative electrode active material layer 21 may contain, in addition to the above, a material that can be contained in a negative electrode active material layer of a solid-state battery. Examples of the material include a solid electrolyte, a conductive additive, a binder, etc. Examples of the solid electrolyte include the same solid electrolytes as those contained in the solid electrolyte layer 4, which will be described later. Examples of the conductive additive include carbon black, natural graphite, carbon fibers, carbon nanotubes, etc. Examples of the binder include a nitrile polymer, a polyester polymer, an acrylic acid polymer, a cellulose polymer, a styrene polymer, a styrene butadiene polymer, a vinyl acetate polymer, a urethane polymer, a fluoroethylene polymer, etc.

The negative electrode current collector layer 22 may include copper, nickel, stainless steel, or the like, without any particular limitation. Examples of the shape of the negative electrode current collector layer 22 include a foil shape, a plate shape, a mesh shape, a nonwoven fabric shape, a foamed shape, etc. A part of the negative electrode current collector layer 22 extends in a predetermined direction to form a negative electrode current collector tab 22a.

### Solid Electrolyte Layer

The solid electrolyte layer 4 is formed between the negative electrode layer 2 and the positive electrode layer 3. In the present embodiment, the solid electrolyte layer 4 has a structure in which the first solid electrolyte layer 43 disposed in contact with the positive electrode layer 3, the second solid electrolyte layer 42, and the third solid electrolyte layer 41 disposed toward the negative electrode layer 2 are stacked in this order.

The first solid electrolyte layer 43 is disposed in contact with the positive electrode active material layer 31 of the positive electrode layer 3. The first solid electrolyte layer 43 may be constituted by any solid electrolyte material, provided that the material can be used as an electrolyte of a solid-state battery. Examples of the solid electrolyte material include an inorganic solid electrolyte such as a sulfide solid electrolyte material, an oxide solid electrolyte material, a halide solid electrolyte, a lithium-containing salt, etc. and a polymer solid electrolyte such as a polyethylene oxide, etc. One kind of the foregoing solid electrolyte materials may be used alone, or two or more kinds thereof may be used in combination.

The first solid electrolyte layer 43 contains a binder in addition to the solid electrolyte material. The binder for the first solid electrolyte layer 43 may be the same substance as the binder that can be contained in the negative electrode active material layer 21. The content of the binder in the first solid electrolyte layer 43 with respect to the mass of the entire first solid electrolyte layer 43 is equal to or greater than the content of the binder in the second solid electrolyte layer 42 with respect to the mass of the entire second solid electrolyte layer 42. The upper limit of the content of the binder in the first solid electrolyte layer 43 is 25 mass %, for example. The content of the binder in the first solid electrolyte layer 43 is preferably 10 mass % to 30 mass %. This range makes the first solid electrolyte layer 43 likely to be stretched and follow the positive electrode layer 3 when the positive electrode layer 3 is pressed. Furthermore, the pressing pressure in a transferring-pressing step to be described later can be reduced.

The first solid electrolyte layer 43 preferably contains a fluorine-based polymer (fluorine-based binder). Examples of the fluorine-based binder include polyvinylidene fluoride(PVdF), etc. Due to the fluorine-based binder, high-pressure pressing and thinning can be easily performed on the solid electrolyte layer.

The first solid electrolyte layer 43 may contain a material that can be used for a solid electrolyte layer of a solid-state battery, in addition to the solid electrolyte material and the binder.

The thickness (length in the lamination direction of the layers) of the first solid electrolyte layer 43 is preferably less than the thickness (length in the lamination direction of the layers) of the second solid electrolyte layer 42. For example, the thickness of the first solid electrolyte layer 43 is preferably 3 μm to 15 μm.

The second solid electrolyte layer 42 is disposed adjacent to the first solid electrolyte layer 43. The second solid electrolyte layer 42 may be constituted by any solid electrolyte material, which may be the same material as the solid electrolyte material constituting the first solid electrolyte layer 43. Similarly to the first solid electrolyte layer 43, the second solid electrolyte layer 42 may contain a binder and the like in addition to the solid electrolyte material. The content of the binder in the second solid electrolyte layer 42 is equal to or less than the content of the binder in the first solid electrolyte layer 43. The content of the binder in the second solid electrolyte layer 42 is preferably 10 mass % to 30 mass %. This range allows the energy density of the solid-state battery 1 to be improved. The second solid electrolyte layer 42 may include a support. Examples of the support include a three-dimensional structure such as a mesh, a woven fabric, a nonwoven fabric, an embossed body, a punched body, an expanded body, a foamed body, etc. The second solid electrolyte layer 42 does not have to include the support.

The thickness (length in the lamination direction of the layers) of the second solid electrolyte layer 42 is preferably greater than the thickness (length in the lamination direction of the layers) of the first solid electrolyte layer 43. For example, the thickness of the second solid electrolyte layer 42 is preferably 10 μm to 50 μm.

The third solid electrolyte layer 41 is an optional layer and is disposed toward the negative electrode layer 2. The third solid electrolyte layer 41 may be disposed adjacent to the negative electrode layer 2. In the case where the solid-state battery 1 includes the intermediate layer 5 as illustrated in in FIG. 1, the third solid electrolyte layer 41 may be disposed adjacent to the intermediate layer 5.

The third solid electrolyte layer 41 may be constituted by any solid electrolyte material, which may be the same material as the solid electrolyte material constituting the first solid electrolyte layer 43. Similarly to the first solid electrolyte layer 43, the third solid electrolyte layer 41 may contain a binder and the like in addition to the solid electrolyte material. The content of the binder in the third solid electrolyte layer 41 with respect to the mass of the entire third solid electrolyte layer 41 is preferably 1 mass % to 20 mass %. This range allows the energy density of the solid-state battery 1 to be improved.

### Positive Electrode Layer

The positive electrode layer 3 includes a positive electrode active material layer 31 and a positive electrode current collector layer 32. In the present embodiment, the positive electrode layer 3 has a configuration in which two positive electrode active material layers 31 are respectively laminated on both surfaces of one positive electrode current collector layer 32. On the other hand, the positive electrode layer 3 is not limited to this configuration, but may have a configuration in which one positive electrode active material layer 31 is laminated on one surface of one positive electrode current collector layer 32.

Each positive electrode active material layer 31 may be constituted by a material that can be used as a positive electrode active material of a solid-state battery, without any particular limitation. Examples of the positive electrode active material constituting each positive electrode active material layer 31 include layered positive electrode active material particles such as LiCoO₂, LiNiO₂, LiCoₓNi_{y}Mn_{z}O₂ (x+y+z=1), LiVO₂, LiCrO₂, etc., a spinel type positive electrode active material such as LiMn₂O₄, Li(Ni_{0.25}Mn_{0.75})₂O₄, LiCoMnO₄, Li₂NiMn₃O, etc., an olivine type positive electrode active material such as LiCoPO₄, LiMnPO₄, LiFePO₄, etc., a solid solution oxide (Li₂MnO₃-LiMO₂ (M=Co, Ni, etc.)), a conductive polymer such as polyaniline, polypyrrole, etc., a sulfide such as Li₂S, CuS, Li—Cu—S compounds, TiS₂, FeS, MoS₂, a Li—Mo—S compound, etc., a mixture of sulfur and carbon, and the like. One kind of the foregoing positive electrode active materials may be used alone, or two or more of kinds thereof may be used in combination.

For example, the thickness (length in the lamination direction of the layers) of the positive electrode active material layer 31 is preferably 3 μm to 15 μm. This range allows the battery capacity of the solid-state battery 1 to be improved.

An insulating frame 6 may be provided along the outer periphery of each positive electrode active material layer 31. The insulating frame 6 can prevent or reduce short-circuiting in the solid-state battery 1 and increase strength of the solid-state battery 1. In the present embodiment, the insulating frames 6 are disposed so as to cover the side surfaces of the two positive electrode active material layers 31 formed on both surfaces of the positive electrode current collector layer 32. Each insulating frame 6 is in contact with a part of the lamination surface of the positive electrode current collector layer 32 and has a gap through which a positive electrode current collector tab 32a described later extends. Each insulating frame 6 may be constituted by any material, and examples thereof include an insulating oxide such as alumina, etc., a resin such as polyvinylidene fluoride (PVDF), etc., and rubber such as styrene-butadiene rubber (SBR) etc., and the like.

The positive electrode current collector layer 32 may be constituted by any material, example thereof include aluminum, stainless steel, conductive carbon (graphite, carbon nanotubes, etc.), and the like. Examples of the shape of the positive electrode current collector layer 32 include a foil shape, a plate shape, a mesh shape, a nonwoven fabric shape, a foamed shape, etc. A part of the positive electrode current collector layer 32 extends in a predetermined direction to form the positive electrode current collector tab 32a.

### Intermediate Layer

The intermediate layer 5 is interposed between the negative electrode layer 2 and the solid electrolyte layer 4. For example, in a case where the solid-state battery 1 is a lithium metal battery, the intermediate layer 5 has a function of causing lithium metal to precipitate uniformly. Due to this function, the interface between the intermediate layer 5 and the solid electrolyte layer 4 is stabilized. In a case where the solid-state battery 1 is a lithium metal secondary battery having the intermediate layer 5, the solid-state battery 1 may be an anode-free battery in which the negative electrode active material layer 21 does not exist at the time of the initial charge. In this case, a lithium metal layer as the negative electrode active material layer 21 is formed after the initial charge and discharge.

The intermediate layer 5 may be constituted by any substance, and examples thereof include a metal that can be alloyed with lithium, amorphous carbon, and the like. Examples of the metal that can be alloyed with lithium include tin (Sn), silicon (Si), zinc (Zn), magnesium (Mg), gold (Au), platinum (Pt), palladium (Pd), silver (Ag), aluminum (Al), bismuth (Bi), antimony (Sb), etc. The metal that can be alloyed with lithium may be nanoparticles. Examples of the amorphous carbon include carbon blacks such as acetylene black, furnace black, Ketjhen black, and the like, coke, activated carbon, etc. The amorphous carbon may be graphitizable carbon (soft carbon), or may be non-graphitizable carbon (hard carbon), CNT (carbon nanotube), fullerene, or graphene. The intermediate layer may contain a binder in addition to the above substances.

### Method of Manufacturing Solid-State Battery

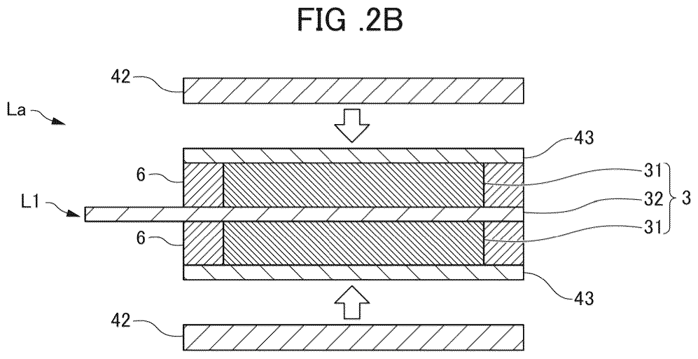

A method of manufacturing a solid-state battery according to the present embodiment will be described below with reference to FIGS. 2A and 2B. The method of manufacturing a solid-state battery according to the present embodiment is adapted for manufacturing a solid-state battery that includes an electrode laminate La in which a negative electrode layer, an intermediate layer, a solid electrolyte layer, and a positive electrode layer are laminated in this order. The method of manufacturing a solid-state battery according to the present embodiment includes a laminate forming step of forming a solid electrolyte layer-positive electrode layer laminate by laminating a solid electrolyte layer 4 on a positive electrode active material layer 31 of a positive electrode layer 3.

The laminate forming step includes a transferring-pressing step, a first pressurizing step, and a second pressurizing step in this order.

As illustrated in FIG. 2A, the transferring-pressing step includes transferring and pressing a first solid electrolyte layer 43 onto the positive electrode active material layer 31 of the positive electrode layer 3. Specifically, the transferring-pressing step can be carried out by using a solid electrolyte layer transfer sheet to transfer the first solid electrolyte layer 43. The solid electrolyte layer transfer sheet is obtained by, for example, applying a slurry prepared by dispersing a material for constituting the first solid electrolyte layer 43 in a solvent to a support sheet, and drying the slurry.

In the transferring-pressing step, the first solid electrolyte layer 43 is transferred and pressed onto the positive electrode active material layer 31 of the positive electrode layer 3 under conditions of a pressure from 50 MPa to 500 MPa at room temperature (e.g., 10° C. to 35° C.). The pressing pressure in the transferring-pressing step is lower than the pressing pressure in the first pressurizing step. The pressing pressure in the transferring-pressing step is preferably 100 MPa. Preferably, the pressing pressure in the transferring-pressing step is lower than the pressing pressure in the second pressurizing step. Since the first solid electrolyte layer 43 contains the binder at a relatively high content, the transferring-pressing step can be carried out at a reduced pressing pressure. Setting the pressing pressure in the transferring-pressing step as low as possible makes it possible to reduce an amount in which the first solid electrolyte layer 43 is stretched in the transferring-pressing step. Thus, it is possible to leave room for stretch of the first solid electrolyte layer 43 in the subsequent steps such as the first pressurizing step, thereby allowing the first solid electrolyte layer 43 to be stretched and follow the positive electrode layer 3. As a result, the bondability between the first solid electrolyte layer 43 and the positive electrode active material layer 31 can be improved.

The first pressurizing step includes pressurizing a laminate Li (a laminate of the positive electrode layer 3 and the first solid electrolyte layers 43) obtained in the transferring-pressing step. The positive electrode active material layer 31 of the positive electrode layer 3 is increased in density (densified) in the first pressurizing step. For example, the first pressurizing step can be carried out under pressing conditions of a pressure from 800 MPa to 1200 MPa at a temperature from 25° C. to 100° C.

As illustrated in FIG. 2B, the second pressurizing step is performed after the first pressurizing step and includes disposing and pressurizing the second solid electrolyte layers 42 on the first solid electrolyte layers 43 of the laminate Li (the laminate of the positive electrode layer 3 and the first solid electrolyte layers 43) to thereby obtain a solid electrolyte layer-positive electrode layer laminate La. For example, the second pressurizing step can be carried out under pressing conditions of a pressure from 50 MPa to 500 MPa at room temperature (e.g., 10° C. to 35° C.). Preferably, the pressing condition in the second pressurizing step is set to 150 MPa.

The method of manufacturing a solid-state battery according to the present embodiment may include another step in addition to the steps described above. For example, steps of obtaining the solid-state battery 1 illustrated in FIG. 1 may be included. For example, the method may include a step of transferring an intermediate layer 5 to a negative electrode layer 2 to obtain a negative electrode layer-intermediate layer laminate, a step of disposing and pressing a third solid electrolyte layer 41 onto the intermediate layer of the negative electrode layer-intermediate layer laminate to obtain a negative electrode layer-intermediate layer-solid electrolyte layer laminate, a step of disposing two negative electrode layer-intermediate layer-solid electrolyte layer laminates such that the solid electrolyte layers face each other, and interposing the solid electrolyte layer-positive electrode layer laminate La between the solid electrolyte layers facing each other, and performing integrating pressing, and any other step.

In each of the above-described steps, the press-bonding may be performed by any apparatus, and example thereof include a roll press apparatus, a plate press apparatus, and an isostatic press (CIP, WIP) apparatus. In a case where the press-bonding is performed by a roll press apparatus, the components to be press-bonded may be conveyed to the roll press apparatus in the same direction or different directions.

It should be noted that the present invention is not limited to the preferred embodiments described above, and can be arbitrarily modified within a range in which the present invention is not inhibited from exerting the effects. For example, the method of manufacturing a solid-state battery of the present invention may include an arbitrary step other than the steps described above.

### EXPLANATION OF REFERENCE NUMERALS

1: Solid-state battery
2: Negative electrode layer
3: Positive electrode layer
31: Positive electrode active material layer
32: Positive electrode current collector layer
4: Solid electrolyte layer
42: Second solid electrolyte layer
43: First solid electrolyte layer

What is claimed is:

1. A method of manufacturing a solid-state battery, the method comprising
forming a solid electrolyte layer-positive electrode layer laminate by laminating a solid electrolyte layer and a positive electrode layer including a positive electrode current collector layer and a positive electrode active material layer such that the solid electrolyte layer is disposed on the positive electrode active material layer,
the forming the solid electrolyte layer-positive electrode layer laminate comprising:
transferring and pressing a first solid electrolyte layer onto the positive electrode active material layer of the positive electrode layer;
pressurizing the positive electrode layer and the first solid electrolyte layer transferred to the positive electrode layer; and
disposing and pressurizing a second solid electrolyte layer onto the first solid electrolyte layer after the pressurizing the positive electrode layer and the first solid electrolyte layer, wherein
a pressing pressure in the transferring and pressing the first solid electrolyte layer is lower than a pressing pressure in the pressurizing the positive electrode layer and the first solid electrolyte layer, and
a content of a binder in the first solid electrolyte layer is equal to or greater than a content of a binder in the second solid electrolyte layer.

2. The method according to claim 1 wherein
the pressing pressure in the transferring and pressing the first solid electrolyte layer is lower than a pressing pressure in the disposing and pressurizing the second solid electrolyte layer.

3. The method according to claim 1 wherein
the first solid electrolyte layer is thinner than the second solid electrolyte layer.

4. The method according to claim 1 wherein
the content of the binder in the first solid electrolyte layer is 5 vol % or more and 25 vol % or less.

5. The method according to claim 1 wherein
the binder in the first solid electrolyte layer includes a fluorine-based binder.

6. The method according to claim 1 wherein
the first solid electrolyte layer has a thickness of 3 μm or more and 15 μm or less.

7. The method according to claim 1 wherein
the pressing pressure in the transferring and pressing the first solid electrolyte layer is 100 MPa.

8. The method according to claim 1 wherein
a pressing pressure in the disposing and pressurizing the second solid electrolyte layer is 150 MPa.
